(19) United States
(12) Patent Application Publication
(10) Pub. No.: US 2025/0033830 A1
(43) Pub. Date: Jan. 30, 2025

(54) Container Lid With Retention Features, Related Containers, Systems, And Methods

(71) Applicant: Graphic Packaging International, LLC, Atlanta, GA (US)

(72) Inventors: Anna Naukkarinen, Helsingborg (SE); Filippa Melin, Malmoe (SE)

(21) Appl. No.: 18/785,200

(22) Filed: Jul. 26, 2024

Related U.S. Application Data
(60) Provisional application No. 63/529,208, filed on Jul. 27, 2023.

(51) Int. Cl. B65D 5/64; B31B 50/00; B31B 105/00; B65D 5/32; B65D 5/54

(52) U.S. Cl. CPC B65D 5/64; B31B 50/00; B65D 5/32; B65D 5/54; B31B 2105/00

(57) ABSTRACT

A container for holding at least one article includes a body extending at least partially around an interior of the container, a closed bottom engaged with the body, and a closed top engaged with the body, the closed top comprising a lid having a lid panel, the lid panel at least partially defining an accessory retention opening for at least partially receiving an accessory associated with the at least one article.

### CROSS-REFERENCE TO RELATED APPLICATION

The present application claims the benefit of and priority to U.S. Provisional Patent Application No. 63/529,208, filed on Jul. 27, 2023.

### INCORPORATION BY REFERENCE

The disclosure of U.S. Provisional Patent Application No. 63/529,208, filed on Jul. 27, 2023, is hereby incorporated by reference for all purposes as if set forth in its entirety.

### BACKGROUND

The present disclosure generally relates to containers for holding one or more articles. In some embodiments, the present disclosure relates to containers with a lid with retention features.

### SUMMARY

According to one aspect, the disclosure is generally directed to a container for holding at least one article, the container comprising a body extending at least partially around an interior of the container, a closed bottom engaged with the body, and a closed top engaged with the body, the closed top comprising a lid comprising a lid panel, the lid panel at least partially defining an accessory retention opening for at least partially receiving an accessory associated with the at least one article.

According to another aspect, the disclosure is generally directed to a combination of blanks for at least partially forming a container for holding at least one article, the combination of blanks comprising a body blank for at least partially forming a body extending at least partially around an interior of the container formed from the combination of blanks, a bottom blank for at least partially forming a closed bottom engaged with the body when the container is formed from the combination of blanks, and a lid blank for at least partially forming a closed top engaged with the body of the container formed from the combination of blanks, the lid blank at least partially defining an accessory retention opening for at least partially receiving an accessory associated with the at least one article when the container is formed from the combination of blanks.

According to another aspect, the disclosure is generally directed to a method of forming a container for holding at least one article, the method comprising obtaining a body blank, obtaining a bottom blank, obtaining a lid blank at least partially defining an accessory retention opening, positioning the body blank forming a body extending at least partially around an interior of the container, positioning the bottom blank engaged with the body to at least partially form a closed bottom of the container, positioning the lid blank engaged with the body to at least partially form a closed top of the container such that the accessory retention opening is positioned for at least partially receiving an accessory associated with the at least one article.

Those skilled in the art will appreciate the above-stated advantages and other advantages and benefits of various additional embodiments reading the following detailed description of the embodiments with reference to the below-listed drawing figures.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the disclosure.

FIG. 1 is a plan view of an exterior surface of a body blank used to form a body of a container according to an exemplary embodiment of the disclosure.

FIG. 2 is a plan view of an exterior surface of a lid blank for forming a lid or top end of a container according to an exemplary embodiment of the disclosure.

FIG. 3 is a plan view of an exterior surface of a bottom blank for forming a bottom of a container according to an exemplary embodiment of the disclosure.

FIG. 4 is a plan view of an exterior surface of a barrier blank for forming a barrier member of a container according to an exemplary embodiment of the disclosure.

FIG. 5 is a plan view of an exterior surface of a lid cover blank for forming a lid cover of a container according to an exemplary embodiment of the disclosure.

FIG. 6 is a perspective view of a container formed from the blanks of FIGS. 1-5 according to an exemplary embodiment of the disclosure.

FIG. 7 is a perspective view of a pair of the containers of FIG. 6 in an open configuration and showing retention of an accessory according to an exemplary embodiment of the disclosure.

Corresponding parts are designated by corresponding reference numbers throughout the drawings.

### DETAILED DESCRIPTION

Containers according to the present disclosure can accommodate articles of numerous different shapes. For the purpose of illustration and not for the purpose of limiting the scope of the disclosure, the following detailed description describes articles such as food products. Such food products can be provided in discrete or granular portions, e.g., as in snacks, for example, candy, gum, chocolate, granola, cereal, nuts, trail mix, raisins, dried fruit, etc. It will be understood that a different type of article such as a different type of food product or different type of article, e.g., powdered food products or powdered articles such as baby formula, powdered nutritional supplements, dehydrated food product, drink mixes, etc., can be held in containers according to the present disclosure without departing from the disclosure. It will be further understood that articles other than food products can be held in containers according to the present disclosure.

In this specification, the terms “lower,” “bottom,” “upper,” and “top” indicate orientations determined in relation to fully erected and upright containers. As described herein, containers can be formed from blanks by overlapping multiple panels, portions, and/or end flaps. Such panels, portions and/or end flaps may be designated herein in terms relative to one another, e.g., “first”, “second”, “third”, etc., in sequential or non-sequential reference, without departing from the disclosure.

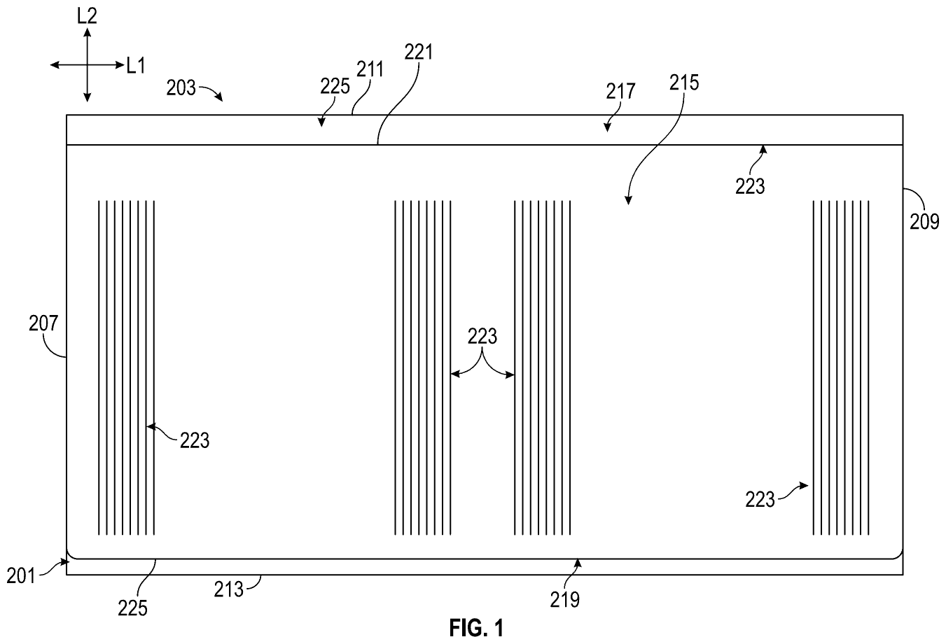

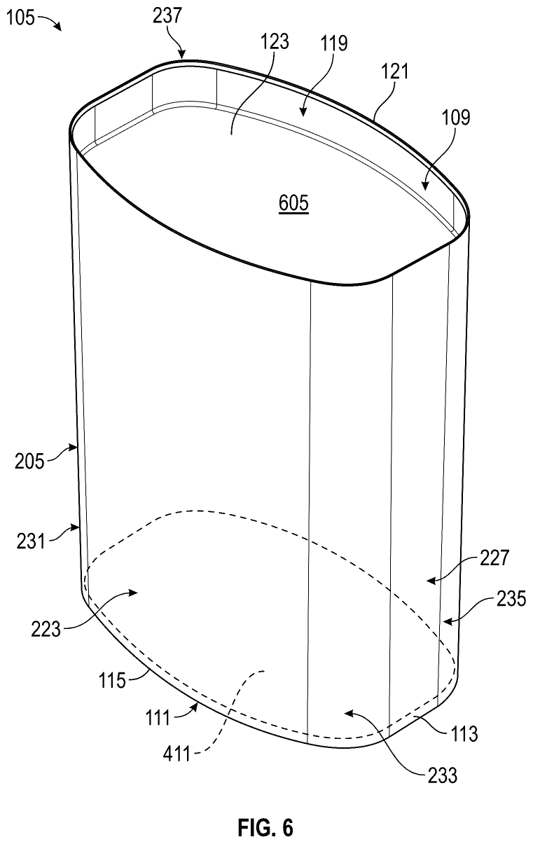

FIGS. 1-5 are plan views of a series of blanks used to form components that assemble to form a container 105 (FIG. 6) according to an exemplary embodiment of the present disclosure. In this regard, in some embodiment the container 105 can be considered an assembly or system of a plurality of components.

Referring to FIG. 1, a plan view of an exterior surface 201 of a body blank 203 for forming a body 205 of the container 105 is illustrated. As described herein, the body 205 is arranged to extend at least partially around an interior 107 of the container 105.

As shown, the body blank 203 can have a longitudinal axis L1 and a lateral axis L2. In some embodiments, the axes L1, L2 can be transposed. In the illustrated embodiment, the body blank 203 can have a generally rectangular configuration with a pair of opposite lateral free edges 207, 209 and a pair of opposite longitudinal free edges 211, 213 extending from a respective endpoint of the free edge 207 to a respective endpoint of the free edge 209.

The body blank 203 can also include a body forming portion 215 defined along a central portion of the body blank 203, a first or top end or lid forming portion 217 defined at an upper peripheral portion/upper marginal portion of the body blank 203, and a second or bottom end forming portion 219 defined at a lower peripheral portion/lower marginal portion of the body blank 203.

As shown, the lid forming portion 217 of the body blank 203 can be at least partially separably connected to the body forming portion 215 and at least partially foldably connected to the body forming portion 215 at a longitudinal line of weakening 221 that can include at least one tear segment and at least one fold line segment.

With continued reference to FIG. 1, the body blank 203 can include multiple pluralities of lateral lines of weakening 223 that can facilitate the formation of curved corners when the body 205 is formed from the body blank 203, as described further herein.

In some embodiments, the bottom forming portion 219 can be at least partially defined by and/or foldably connected to the body forming portion 215 at a longitudinal line of weakening 225.

In some embodiments, the body blank 203 can be comprised of one or more paperboard materials made predominantly from cellulose fibers or paper fibers. The material may be provided in the form of a continuous web or may be provided as individual sheets of material. The paperboard material may be a single ply or multi ply material and may be a laminate comprising one or more reinforcing, moisture resistant non-cellulosic layers of materials such as films and coatings, metal foil, etc. The paperboard material may be coated, printed, embossed, etc. and may comprise fillers, pigments, binders and other additives as known in the art. In some embodiments, the paperboard material can be devoid of polymeric and/or metallic materials.

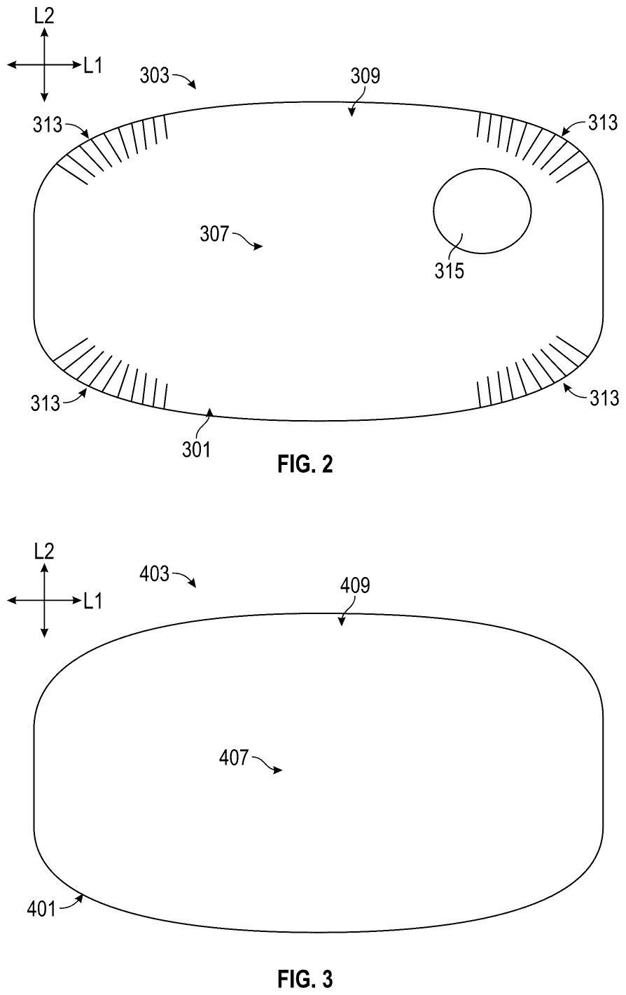

Turning to FIG. 2, the exterior surface 301 of a lid blank 303 for at least partially forming a lid 109 of the container 105 is illustrated. As shown, the lid blank 303 can have the longitudinal axis L1 and the lateral axis L2, and can include a central portion 307 and a marginal portion 309 extending to the peripheral edges of the lid blank 303.

In some embodiments, the marginal portion 309 of the lid blank 303 can be at least partially foldably connected to the central portion 307 at a generally rounded rectangular/elliptical fold line. In other embodiments, one or more foldable connections between the marginal portion 309 of the lid blank 303 and the central portion 307 of the lid blank 303 can be formed upon formation of the lid 109 of the container 105, as described further herein.

As also shown, the lid blank 303 can include multiple pluralities of oblique and/or curved lines of weakening 313 arranged along corner portions of the lid blank 303. As described further herein, the lines of weakening 313 can facilitate formation of the lid 109/container 105.

With continued reference to FIG. 2, an accessory retention opening 315 can be at least partially defined in the central portion 307 of the blank 303 and lid panel 311 formed therefrom. As described further herein, the accessory retention opening 315 is for at least partially receiving and/or maintaining an accessory for or component of the container 105.

It will be understood that the lid blank 303 can be formed from one or more materials that are the same or similar to those that form the body blank 203 as described above, e.g., paperboard materials.

Turning to FIG. 3, the exterior surface 401 of a bottom blank 403 for at least partially forming a closed bottom or closed end 111 of the container 105 is illustrated.

As shown, the bottom blank 403 can have a configuration generally similar to that of the lid blank 303 described above, e.g., having the longitudinal axis L1 and the lateral axis L2, a central portion 407, and a marginal portion 409 extending to the peripheral edges of the bottom blank 403. In some embodiments, the marginal portion 409 can be at least partially foldably connected to the central portion 407 at a generally rounded rectangular/elliptical fold line, though the blank 403 can be devoid of such fold line without departing from the disclosure.

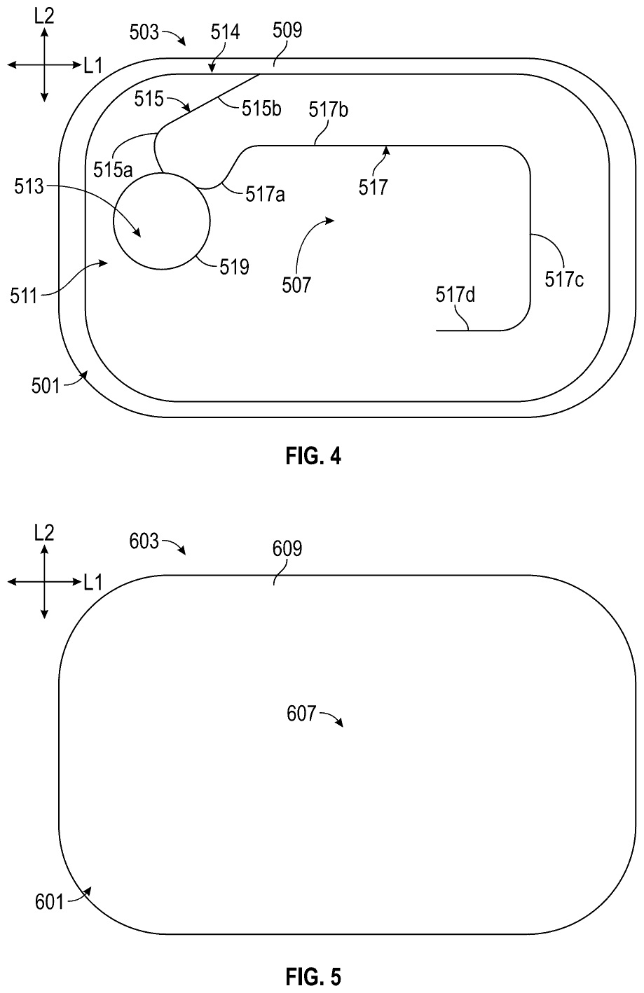

Turning to FIG. 4, the exterior surface 501 of a barrier blank 503 for forming a barrier member 505 of the construct 105 is illustrated.

The barrier blank 503 can have the longitudinal axis L1 and the lateral axis L2, and can include a central portion 507 and a marginal portion 509 extending to the peripheral edges of the barrier blank 503. In some embodiments, the marginal portion 509 of the barrier blank 503 can be at least partially foldably connected to the central portion 507 at one or more lines of weakening, e.g., fold lines. In other embodiments, one or more foldable connections between the marginal portion 509 of the blank 503 and the central portion 507 of the blank 503 can be formed upon formation of the barrier member 505.

The marginal portion 509 of the blank 503 can be at least partially separable from the central portion 507 of the blank 503 and barrier member 505 formed therefrom at least one line of weakening, for facilitating access to the interior 107 of the container 105, as described further herein.

In the illustrated embodiment, the barrier blank 503 and barrier member 505 formed therefrom can be formed from a laminate structure that includes a plurality of layers in general registration, with vertically adjacent layers in overlapping and/or at least partial face-to-face contact with one another.

As described herein, the barrier blank 503 can have the form of a laminate structure that can include at least an upper portion 511 and a lower portion 513 coupled to the upper portion 511. In some embodiments, the upper portion 511 can have at least one layer that forms a top web, and in some embodiments, the lower portion 513 can include at least one layer that forms a bottom web or a base web.

In some embodiments, the upper portion 511 can have at least one layer comprising one or more of or can be a laminate of one or more layers that can comprise polymeric materials, composite materials, and/or metallic materials. In some embodiments, such polymeric materials can include polyethylene terephthalate. In some embodiments, such composite materials can include a paper or paperboard product. In some embodiments, such metallic materials can include a metallic foil such as aluminum foil. In instances in which the upper portion 511 includes multiple laminated layers, two or more of such layers can be coupled to one another, for example, with an adhesive such as glue, via ultrasonic welding, via heat sealing, etc.

In some embodiments, the lower portion 513 can have at least one layer comprising one or more of or can be a laminate of one or more layers that can comprise polymeric materials, composite materials, and/or metallic materials. In some embodiments, such polymeric materials can include polyethylene terephthalate. In some embodiments, such composite materials can include a paper or paperboard product. In some embodiments, such metallic materials can include a metallic foil such as aluminum foil. In instances in which the lower portion 513 includes multiple laminated layers, two or more of such layers can be coupled to one another, for example, with an adhesive such as glue, via ultrasonic welding, via heat sealing, etc.

The upper portion 511 and the lower portion 513 of the barrier blank 503 and barrier member 505 formed therefrom can be coupled to one another, for example, with an adhesive such as glue, via ultrasonic welding, via heat sealing, etc. In some embodiments, the upper portion 511 and the lower portion 513 of the barrier blank 503 and barrier member 505 formed therefrom can be considered portions of a single material layer.

As shown in FIG. 4, the marginal portion 509 of the blank 503 and the central portion 507 of the blank 503 can be at least partially separable from one another via a pair of spaced apart lines of weakening 514, 515, 517 extending at least partially therealong. As shown, each line of weakening 515, 517 can intersect an access opening 519 in the upper portion 511 of the barrier blank 503/barrier member 505 that exposes the lower portion 513 therebelow.

As shown, the line of weakening 514 can have a configuration that follows and extends substantially around the perimeter of the blank 503, spaced inwardly from the free edges thereof.

In the illustrated embodiment, the line of weakening 515 can include a first generally laterally-extending curved segment 515a extending away from the access opening 519 and intersecting a generally-oblique extending segment 515b that intersects a respective portion of the line of weakening 514.

The line of weakening 517 can include a first generally longitudinally-extending curved segment 517a extending away from the access opening 519 and intersecting a generally-longitudinally extending segment 517b. The segment 517b can intersect a generally laterally-extending segment 517c that intersects a generally-longitudinally extending lower segment 517d.

In some embodiments, one or more portions of one or both of the lines of weakening 514, 515, 517 can extend fully or partially through the barrier blank 503/barrier member 505.

Turning to FIG. 5, the exterior surface 601 of a lid cover blank 603 for at least partially forming a lid cover 605 of the container 105 is illustrated.

As shown, the lid cover blank 603 can have a configuration generally similar to that of the lid blank 303 and the bottom blank 403 described above, e.g., having the longitudinal axis L1 and the lateral axis L2, a central portion 607, and a marginal portion 609 extending to the peripheral edges of the bottom blank 603. In some embodiments, the marginal portion 609 can be at least partially foldably connected to the central portion 607 at a generally rounded rectangular/elliptical fold line, though the blank 603 can be devoid of a fold line without departing from the disclosure.

One or more of the blanks 203, 303, 403, 503, 603 and one or more of the associated features thereof can have a different arrangement and/or configuration without departing from the disclosure. For example, and as described further herein, the body blank 203 can be formed into a body 205 of the container 105 with a generally rounded rectangular or elliptical vertical cross-section, with each of the blanks 303, 403, 503 having a corresponding cross-section for being at least partially received in the interior 107 of the container 105/body 205. In some embodiments, the body 205 can be formed with a different vertical cross-sectional configuration, and the blanks 303, 403, 503 can have a different configuration corresponding to such vertical cross-sectional configuration.

As described herein, the blanks 203, 303, 403, 503, 603 can be further formed to provide components that assemble to form the container 105. In this regard, the blanks 203, 303, 403, 503, 603 can be provided in combination for forming a system in the form of the container 105.

Turning to FIG. 6, formation of the container 105 from the blanks 203, 303, 403, 503, 603 will be described according to an exemplary embodiment of the disclosure.

The body blank 203 can be positioned to extend at least partially around an interior 107 of the container 105. In one embodiment, the body blank 203 can be at least partially bent, curved, folded, etc., for example, at the fold lines 223, into a generally elliptical or rounded rectangular cross-section, with portions of the body blank 203 proximate the free edges 207, 209 at least partially overlapped to form a seam arrangement, which can be maintained with a strip of adhesive tape. In some embodiments, the free edges 207, 209 of the blank 203 can be brought into generally edge-to-edge contact.

The overlapping/meeting portions of the body blank 203 can be joined, for example, with an adhesive such as glue, with an adhesive coated tape or substrate, and/or through another method of joining such as welding, interfering locking arrangements, etc.

As shown, the body 205 of the container 105 can thus be formed, with respective portions of the body forming portion 215 of the blank 203 forming a front wall or front panel 223, a first side wall or first side panel 225, a second side wall or second side panel 227, and a back wall or back panel 229. Respective curved corners 231, 233, 235, 237 can be formed between the respective panels 223, 225, the respective panels 223, 227, the respective panels 225, 229, and the respective panels 227, 229. In some embodiments, the blank 203 can be provided with one or more lines of weakening for facilitating such formation of rounded or curved corners of the body 205.

As described above, in some embodiments, the body 205 of the container 105 can be formed into a different cross-sectional configuration, e.g., circular, elliptical, triangular, rectangular, square, pentagonal, hexagonal, heptagonal, octagonal, etc., including rounded or curved corner variations thereof.

With continued reference to FIG. 6, the closed bottom 111 of the container 105 can be formed and engaged with the body 205, according to the illustrated embodiment, by positioning the bottom blank 403 in the interior 107 of the container 105, with the central portion 407 of the bottom blank 403 positioned in generally perpendicular relation with the panels 223, 225, 227, 229 so as to form a bottom panel 411 of the container 105. As shown, the bottom blank 403 can be positioned a vertical distance above a longitudinal free edge of the container 105.

The marginal portion 409 of the bottom blank 403 can be bent or folded downwardly relative to the central portion 407 of the blank 403/bottom panel 411 and attached, e.g., adhered with an adhesive such as glue, welded, or otherwise attached, to the interior surface of one or more of the panels 223, 225, 227, 229 and corners 231, 233, 235, 237 of the body 205 of the container 105.

Simultaneously or thereafter, the bottom forming portion 219 of the blank 203 can be bent/curled or folded, for example, at the fold line 225, over the marginal portion 409 of the bottom blank 403 to form a bottom flange 113 of the container 105 that extends downwardly from the bottom panel 411. In some embodiments, the bottom forming portion 219 of the blank 203 can be crimped in such an arrangement. The bottom flange 113 can define a bottom edge 115 of the container 105.

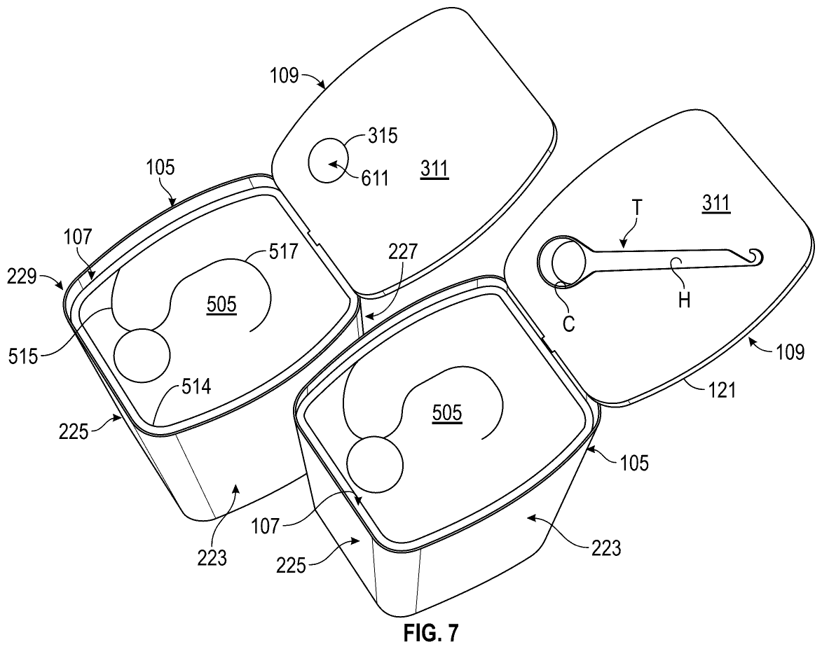

With momentary reference to FIG. 7, the barrier blank 503 can be positioned in the interior 107 of the container 105, with the central portion 507 of the barrier blank 503 positioned in generally perpendicular relation with the panels 223, 225, 227, 229. As shown, the barrier blank 503 can be positioned a vertical distance below the lid 109/container 105, as described further herein.

In some embodiments, the barrier blank 503 can be inserted into the interior 107 of the container 105, formed into the barrier member 505, and/or attached to the body 205 of the container 105 via contact with a plunger or other moveable tool for positioning the blank 503/member 505.

In this regard, at least a portion of the marginal portion 509 of the blank 503/barrier member 505 can be bent or folded upwardly relative to the central portion 507 of the barrier blank 503 and attached, e.g., adhered with an adhesive such as glue, welded, or otherwise attached, to the interior surface of one or more of the panels 223, 225, 227, 229 and corners 231, 233, 235, 237 of the body 205 of the container 105 to form the barrier member 505.

The lid blank 303 can be positioned in the interior 107 of the container 105 above the barrier member 505, with the central portion 307 of the lid blank 303 positioned in generally perpendicular relation with the panels 223, 225, 227, 229 so as to form a lid panel 311 of the container 105.

The marginal portion 309 of the lid blank 303 can be bent or folded downwardly relative to the central portion 307 of the blank 303/lid panel 311, for example, at a fold line, and attached, e.g., adhered with an adhesive such as glue, welded, or otherwise attached, to the interior surface of one or more of the panels 223, 225, 227, 229 and corners 231, 233, 235, 237 of the body 205 of the container 105. It will be understood that the lines of weakening 313 can facilitate positioning of the marginal portion 309 relative to corners 231, 233, 235, 237.

Simultaneously or thereafter, the lid forming portion 217 of the blank 203 can be bent/curled or folded, for example, at the fold line 221, over the marginal portion 309 of the lid blank 303 to form a lid collar or lid flange 119 of the lid 109 of the container 105. In some embodiments, the lid forming portion 217 of the blank 203 can be crimped in such an arrangement. The lid flange 119 can define a top edge 121 of the lid 109/container 105 and can extend upwardly from the lid panel 311 such that a lid recess or recessed portion 123 of the lid 109 can be formed between the top edge 121 and the lid panel 311.

As shown in FIG. 7, prior to, during, or following formation the aforementioned arrangement of the lid panel 311 and lid forming portion 217 of the blank 203 to form the lid 109 of the container 105, the central portion 607 of the lid cover blank 603 can be positioned in generally perpendicular relation with the panels 223, 225, 227, 229 and spaced above the lid panel 311 in the recessed portion 123 of the lid 109 to form the lid cover 605. In this regard, a lid compartment 611 can be formed at least partially between the lid cover 605 and the lid panel 311, with the accessory retention opening 315 providing a passage from the interior 107 of the container 105 into the lid compartment 611.

In some embodiments, the marginal portion 609 of the lid cover blank 603 can be bent or folded downwardly relative to the central portion 607 of the blank 603/lid cover 605, for example, at the fold line 610, and attached, e.g., adhered with an adhesive such as glue, welded, or otherwise attached, to the interior surface of the lid flange 119 of the container 105.

It will be understood that, prior to the formation of one of the bottom end 111 and the lid 109 of the container 105, one or more articles can be deposited and held in the interior 107 of the container 105. In some embodiments, a container 105 can be supported in a generally stationary position and one or more filling devices can be brought into proximity with the container 105 for depositing articles in the interior 107 of the container 105.

In some embodiments, the barrier member 505, and, optionally, one or more of the lid panel 311, lid cover 605, and/or lid 109 can be positioned/and formed. The container can be inverted, e.g., such that the barrier member 505 is positioned relatively lower toward a supporting surface and in such an arrangement that a lower portion of the body 205 is open to the interior 107 of the container 105.

In such an arrangement, articles can be deposited in the interior 107 of the container 105, e.g., so as to rest upon the barrier member 505 and fill toward an open bottom of the container 105. Once one or more such filling operations are completed, the closed bottom 111 of the container 105 can be formed in the manner described above.

However, it will be understood that the container 105 can be filled with one or more articles in an upright configuration following formation of the closed bottom 111 and prior to the positioning/formation of one or more of the barrier member 505, lid panel 311, lid cover 605, and/or lid 109.

As shown in FIG. 7, a tool or accessory T can be provided for use with the articles in the interior 107 of the container 105. In some embodiments, the accessory T can have the form of a scoop with a generally elongate handle H extending away from a recessed cup C. The accessory T can be formed from one or more of composite, polymeric, and/or metallic materials. It will be understood that the accessory T can have a different configuration, e.g., a spoon, ladle, fork, etc.

It will be understood that the cup C of the accessory T can be at least partially removably received in the accessory retention opening 315 of the lid panel 311 so as to extend at least partially into the lid compartment 611. In this regard, at least a portion of the cup C of the accessory T can have a diameter the same or similar to that of the accessory retention opening 315. In some embodiments, the cup C can have a generally tapered configuration so as to facilitate a press fit with an edge(s) of the lid panel 311 surrounding the accessory retention opening 315.

It will be understood that such placement of the accessory T at least partially in the lid compartment 611 can occur prior to or following formation of the lid panel 311 from the lid blank 303.

In some embodiments, the accessory T can form a portion of the container 105. In some embodiments, the accessory T can be separate from the container 105 and provided in combination therewith.

As shown in FIG. 7, in order to access the interior 107 of the container 105, a user can separate the lid 109 from the body 205 of the container 105 along tear line segments of the line of weakening 221 and hingably/foldably move the lid 109 about a fold line segment of the line of weakening 221 to allow the lid 109 to be arranged in an open position, in which the lid 109 is moved away from the interior 107 of the container 105, and a closed position, in which the lid 109 at least partially overlies and/or is at least partially received in the interior 107 of the container 105. When the lid 109 is in the closed position, a closed top of the container 105 can be provided

As shown, with the lid 109 in the open position, the accessory T can be at least partially exposed away from the lid panel 311, with the handle H thereof extending away therefrom in generally parallel and planar relation with the lid panel 311. In this regard, the accessory T is conveniently positioned for retrieval by a user for scooping articles in the interior 107 of the container 105. Furthermore, the retention features of the container 105 are such that the accessory T can be at least partially held at least partially recessed in the lid compartment 611 when not in use, e.g., so as to avoid misplacement, clutter, etc.

When desired, a user can remove the barrier member 505 to access articles held therebeneath. In one embodiment, the user can press the barrier member 505 at an access feature, e.g., the access opening 519, or other selected region to cause at least partial separation of the central portion 507 from the marginal portion 509 of the barrier member 505 respective lines of weakening 515, 517 to further access the interior 107 of the container 105.

Upon at least partial separation of the central portion 507 of the barrier member 505 a described above, a user can insert on or more of his or her fingers into the interior 107 of the container 105 below the barrier member 505 to engage the interior surface of the barrier member 505 and pull the central portion 507 thereof upwardly to cause separation of the central portion 507 from the remainder of the marginal portion 509 along respective lines of weakening.

In this regard, upon pushing or pulling by a user on the barrier member 505, one or more lines of weakening can be caused to propagate further therealong to facilitate separation of the central portion 507 from the marginal portion 509 of the barrier member 505.

Due to the configuration of the barrier member 505 and the laminate structures that form the blank 503/barrier member 505, the blank 503/barrier member 505 can provide superior barrier properties to maintain one or more conditions of articles in the interior 107 of the container 105, e.g., to maintain freshness, to maintain a sealed condition thereof, to maintain a moisture barrier, to avoid contact with debris from the environment, to prevent access by pests, etc., for example, as compared to a barrier member in which lines of weakening fully penetrate such structures.

Furthermore, this arrangement of lines of weakening in the blank 503/barrier member 505 can provide superior tear resistance to incidental forces, e.g., those not intentionally applied by a user during opening, for example, during installation of the blank 503/barrier member 505 in the interior 107 of the container 105, during storage and/or transport, pressure changes, etc.

It will be understood that the container 105 and/or one or more components thereof can have a different configuration without departing from the disclosure. For example, it will be understood that one or more of the blanks and members described herein can be shaped, sized, or otherwise configured to engage such container structures. Such container structures can include Boardio®, available from Graphic Packaging International, LLC of Atlanta, GA, Sealio®, available from Graphic Packaging International, LLC of Atlanta, GA, and Cekacan®, available from Graphic Packaging International, LLC of Atlanta, GA, to name a few.

The blanks according to the present disclosure can be, for example, formed from coated paperboard and similar materials. For example, the interior and/or exterior sides of the blanks can be coated with a clay coating. The clay coating may then be printed over with product, advertising, price coding, and other information or images. The blanks may then be coated with a varnish to protect any information printed on the blank. The blanks may also be coated with, for example, a moisture barrier layer, on either or both sides of the blanks. In accordance with the above-described embodiments, the blank may be constructed of paperboard of a caliper such that it is heavier and more rigid than ordinary paper. The blanks can also be constructed of other materials, such as cardboard, hard paper, or any other material having properties suitable for enabling the containers to function at least generally as described above. The blanks can also be laminated to or coated with one or more sheet-like materials at selected panels or panel sections.

In accordance with the above-described embodiments of the present disclosure, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed portion in the material along the desired line of weakness; a cut that extends partially into a material along the desired line of weakness, and/or a series of cuts that extend partially into and/or completely through the material along the desired line of weakness; and various combinations of these features.

As an example, a tear line can include: a slit that extends partially into the material along the desired line of weakness, and/or a series of spaced apart slits that extend partially into and/or completely through the material along the desired line of weakness, or various combinations of these features. As a more specific example, one type of tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the spaced apart slits to be replaced with a continuous slit, a continuous score, or the like. For example, a cut line can be a continuous slit or could be wider than a slit without departing from the present disclosure. Also, a tear line can be a series of cut scores passing completely, or partially, through the material, that are separated by nicks.

The term “glue” is intended to encompass all manner of adhesives commonly used to secure container panels or portions in place.

The foregoing description of the disclosure illustrates and describes various exemplary embodiments. Various additions, modifications, changes, etc., could be made to the exemplary embodiments without departing from the spirit and scope of the disclosure. It is intended that all matter contained in the above description or shown in the accompanying drawings shall be interpreted as illustrative and not in a limiting sense. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A container for holding at least one article, the container comprising:
a body extending at least partially around an interior of the container,
a closed bottom engaged with the body; and
a closed top engaged with the body, the closed top comprising a lid comprising a lid panel, the lid panel at least partially defining an accessory retention opening for at least partially receiving an accessory associated with the at least one article.

2. The container of claim 1, wherein the lid further comprises a lid cover spaced away from the lid panel such that a lid compartment is at least partially defined therebetween, the accessory retention opening provides access to the lid compartment such that the lid compartment is for at least partially receiving the accessory.

3. The container of claim 2, wherein the lid is repositionable between a closed position at least partially overlying the body and an open position at least partially raised away from the body, the lid comprising a lid flange extending upwardly from the lid panel to at least partially form a lid recess.

4. The container of claim 3, wherein the lid flange is at least partially separable from and at least foldably connected to the body at a line of weakening.

5. The container of claim 4, wherein the container further comprises at least one barrier member attached to the body in the interior of the container.

6. The container of claim 5, wherein the at least one barrier member comprises a central portion at least partially separable from a marginal portion for facilitating access to the interior of the container.

7. The container of claim 2, further comprising the accessory.

8. The container of claim 7, wherein the accessory is removably received in the accessory retention opening.

9. The container of claim 8, wherein the accessory comprises a cup at least partially positioned in the lid compartment and a handle extending away from the cup such that the handle extends in generally parallel relation with the lid panel.

10. A combination of blanks for at least partially forming a container for holding at least one article, the combination of blanks comprising:
a body blank for at least partially forming a body extending at least partially around an interior of the container formed from the combination of blanks;
a bottom blank for at least partially forming a closed bottom engaged with the body when the container is formed from the combination of blanks; and
a lid blank for at least partially forming a closed top engaged with the body of the container formed from the combination of blanks, the lid blank at least partially defining an accessory retention opening for at least partially receiving an accessory associated with the at least one article when the container is formed from the combination of blanks.

11. The combination of blanks of claim 10, further comprising a lid cover panel for forming a lid cover spaced away from the lid panel formed from the lid blank when the container is formed from the combination of blanks such that a lid compartment is at least partially defined therebetween, the accessory retention opening for providing access to the lid compartment such that the lid compartment is for at least partially receiving the accessory when the container is formed from the combination of blanks.

12. The combination of blanks of claim 11, further comprising at least one barrier blank for forming at least one barrier member attached to the body in the interior of the container formed from the combination of blanks.

13. The combination of blanks of claim 12, wherein the at least one barrier blank comprises a central portion at least partially separable from a marginal portion for facilitating access to the interior of the container formed from the combination of blanks.

14. The combination of blanks of claim 11, further in combination with the accessory.

15. A method of forming a container for holding at least one article, the method comprising:
obtaining a body blank;
obtaining a bottom blank;
obtaining a lid blank at least partially defining an accessory retention opening;
positioning the body blank forming a body extending at least partially around an interior of the container;
positioning the bottom blank engaged with the body to at least partially form a closed bottom of the container;
positioning the lid blank engaged with the body to at least partially form a closed top of the container such that the accessory retention opening is positioned for at least partially receiving an accessory associated with the at least one article.

16. The method of claim 15, further comprising positioning a lid cover spaced away from the lid panel such that a lid compartment is at least partially defined therebetween, the accessory retention opening provides access to the lid compartment such that the lid compartment is for at least partially receiving the accessory.

17. The method of claim 16, wherein the lid is repositionable between a closed position at least partially overlying the body and an open position at least partially raised away from the body, and the method comprises forming a lid flange extending upwardly from the lid panel to at least partially form a lid recess.

18. The method of claim 17, wherein the lid flange is at least partially separable from and at least foldably connected to the body at a line of weakening.

19. The method of claim 18, further comprises attaching at least one barrier member to the body in the interior of the container.

20. The method of claim 19, wherein the at least one barrier member comprises a central portion at least partially separable from a marginal portion for facilitating access to the interior of the container.

21. The method of claim 16, further comprising obtaining the accessory.

22. The method of claim 21, further comprising removably receiving the accessory in the accessory retention opening.

23. The method of claim 22, wherein the accessory comprises a cup and a handle extending away from the cup, and the method comprise at least partially positioning the cup in the lid compartment such that the handle extends in generally parallel relation with the lid panel.
